(19) United States
(12) Patent Application Publication
(10) Pub. No.: US 2022/0109331 A1
(43) Pub. Date: Apr. 7, 2022

(54) INDUCTIVE CHARGING TRACK SYSTEM

(71) Applicant: Kalani Ventimiglio, Oakley, CA (US)

(72) Inventor: Kalani Ventimiglio, Oakley, CA (US)

(21) Appl. No.: 17/474,400

(22) Filed: Sep. 14, 2021

Related U.S. Application Data
(60) Provisional application No. 63/088,491, filed on Oct. 7, 2020.

(51) Int. Cl. H02J 50/40; H02J 50/10; H02J 50/00; H02J 7/02

(52) U.S. Cl. CPC H02J 50/402; H02J 50/10; H02J 2310/22; H02J 7/02; H02J 50/005

(57) ABSTRACT

An inductive charging track system for wirelessly charging electronic devices. An inductive charging track comprises a flexible housing and a power transfer component retained within the housing. The housing is configured to attach to a wall or surface. The power transfer component comprises a transmitter circuit and a plurality of charging regions. An A/C input is configured to connect the transmitter circuit to a domestic power supply. Each charging region comprises an inductive transmitter coil configured to transfer energy to the electronic devices via inductive coupling. The inductive charging track system connects a plurality of the inductive charging tracks in series to provide wireless power over a larger surface area.

### CROSS-REFERENCE TO RELATED APPLICATION

The present application claims priority to, and the benefit of, U.S. Provisional Application No. 63/088,491, which was filed on Oct. 7, 2020 and is incorporated herein by reference in its entirety.

### BACKGROUND

The present invention generally relates to power charging systems, and more specifically to an inductive charging track that can replace traditional plugs in a residential or commercial setting. Accordingly, the present specification makes specific reference thereto. However, it is to be appreciated that aspects of the present invention are also equally amenable to other like applications, devices and methods of manufacture.

Inductive charging (also known as wireless charging or cordless charging) is a type of wireless power transfer. Electromagnetic induction is used to provide electricity to portable or non-fixed electrical devices. The most common inductive charging application is the Qi wireless charging standard for smartphones, smartwatches, tablets, and other portable electronics. Inductive charging is also used in vehicles, power tools, and medical devices. The electronic equipment is simply placed near a charging station or inductive pad without needing to be precisely aligned or make electrical contact with a dock or plug.

An alternating current is run through an induction coil in the charging station or pad and energy is transferred via inductive coupling. The moving electric charge creates a magnetic field. The magnetic field fluctuates in strength as the AC current is continually changing amplitude. A changing magnetic field generates an electromotive force. This fluctuation creates an alternating electric current in a second induction coil in the electronic device. The alternating current is then converted to direct current with a rectifier and used to charge a battery or provide operating power for the electronic device.

Conventional power outlets and prongs have inherent safety concerns. House fires can occur when traditional plugs and power strips are overloaded. Children are often at risk for electrocution when they have unsupervised access to outlets. Adding additional outlets to existing construction is expensive, inconvenient, and unsightly. Additionally, it is not always possible due to the underlying construction of the wall.

Therefore, there exists a long felt need in the art for a way to charge portable electronics and non-fixed electrical items, such as lights, speakers, etc. There is also a long felt need for a safe alternative to extension cords to power these devices when there is no convenient outlet positioned where it is needed. Finally, there is a long felt need for a charging system that is easy to deploy and does not require professional installation.

In this manner, the improved inductive charging system of the present invention accomplishes all of the forgoing objectives, thereby providing an easy solution charging portable and non-fixed electrical devices. A primary feature of the present invention is an inductive charging track that eliminates the use of plugs, prongs, and unnecessary GFCI applications. The improved inductive charging system of the present invention utilizes inductive charging as a safe alternative to conventional power outlets.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an inductive charging track. The inductive charging track is configured to wirelessly charge a plurality of rechargeable electronic devices simultaneously. The inductive charging track comprises a housing and a power transfer component. The housing is adapted to receive and retain the plurality of rechargeable electronic devices. The housing may be a flexible mat that is rollable or constructed in a rigid track. The housing may be deployed horizontally on a surface or attach vertically on a wall.

The housing comprises an outward facing side, a wall facing side, and a perimeter. The outward facing side is the charging surface. The plurality of rechargeable electronic devices may be laid on or placed in proximity to the outward facing side for recharging. The outward facing side may comprise a plurality of electronic device retaining components for holding the plurality of rechargeable electronic devices in place near the housing when the housing is attached to a vertical surface. The wall facing side comprises a wall attachment component for attaching the housing to a wall. The wall facing side may further comprise a metal back plate for positioning between the wall facing side and the wall. The inductive charging track may further comprise a mounting channel. The mounting channel is adapted to mount to the wall and receive and hold the housing in place.

The housing further comprises a proximal end and a distal end. The inductive charging track further comprises an A/C input integrated into the proximal end. The inductive charging track may further comprise a power cord. The power cord is adapted to electrically connect the A/C input to an external power source via an outlet. The inductive charging track may further comprise an A/C outlet integrated into the distal end.

The power transfer component is encased within and encapsulated by the housing. The power transfer component comprises a transmitter circuit and an inductive component. The inductive component is in electronic communication with and electrically coupled to the transmitter circuit. The A/C input electrically couples the transmitter circuit to the external power source. The inductive charging track may further comprise a controller for operating the inductive charging track. The controller is in electrical communication with the transmitter circuit.

The inductive component comprises a plurality of charging regions. Each charging region comprising at least one inductive transmitter coil. Each inductive charging coil functions as a transmitter to convert the A/C power to an electromagnetic field that is capturable by a corresponding receiving coil in one of the electronic devices. The plurality of inductive transmitter coils are arranged in a planar orientation throughout the housing. The plurality of inductive transmitter coils are electrically interconnected in series, parallel, or a combination thereof.

The inductive charging track may further comprise a plurality of USB connections. Each USB connection is integrated into the housing and receives power via an electrical connection to the transmitter circuit. The inductive charging track may further comprise a plurality of lighting components. Each lighting component is attachable to or integrated into the outward facing side of the housing or along the perimeter. Each lighting component is configured to be powered inductively by the inductive charging track.

In an additional embodiment, the subject matter disclosed and claimed herein comprises an inductive charging system. The inductive charging system comprises a plurality of inductive charging tracks and a plurality of connector components. Each inductive charging track is configured to wirelessly charge a plurality of rechargeable electronic devices simultaneously. Each inductive charging track comprises a housing and a power transfer component. The housing is adapted to receive and retain the plurality of rechargeable electronic devices. The housing may be a flexible mat that is rollable or constructed in a rigid track. The housing may be deployed horizontally on a surface or attach vertically on a wall.

The housing comprises an outward facing side, a wall facing side, and a perimeter. The outward facing side is the charging surface. The plurality of rechargeable electronic devices may be laid on or placed in proximity to the outward facing side for recharging. The outward facing side may comprise a plurality of electronic device retaining components for holding the plurality of rechargeable electronic devices in place near the housing when the housing is attached to a vertical surface. The wall facing side comprises a wall attachment component for attaching the housing to a wall. The wall facing side may further comprise a metal back plate for positioning between the wall facing side and the wall. The inductive charging track may further comprise a plurality of mounting channels. The mounting channels are adapted to mount to the wall and receive and hold the housing in place.

The housing further comprises a proximal end and a distal end. Each inductive charging track further comprises an A/C input integrated into the proximal end. Each inductive charging track may further comprise a power cord. The power cord is adapted to electrically connect the A/C input to an external power source via an outlet. Each inductive charging track may further comprise an A/C outlet integrated into the distal end.

The power transfer component is encased within and encapsulated by the housing. The power transfer component comprises a transmitter circuit and an inductive component. The inductive component is in electronic communication with and electrically coupled to the transmitter circuit. The A/C input electrically couples the transmitter circuit to the external power source. Each inductive charging track may further comprise a controller for operating the inductive charging track. The controller is in electrical communication with the transmitter circuit.

The inductive component comprises a plurality of charging regions. Each charging region comprising at least one inductive transmitter coil. Each inductive charging coil functions as a transmitter to convert the A/C power to an electromagnetic field that is capturable by a corresponding receiving coil in one of the electronic devices. The plurality of inductive transmitter coils are arranged in a planar orientation throughout the housing. The plurality of inductive transmitter coils are electrically interconnected in series, parallel, or a combination thereof.

Each inductive charging track may further comprise a plurality of USB connections. Each USB connection is integrated into the housing and receives power via an electrical connection to the transmitter circuit. Each inductive charging track may further comprise a plurality of lighting components. Each lighting component is attachable to or integrated into the outward facing side of the housing or along the perimeter. Each lighting component is configured to be powered inductively by the inductive charging track.

The plurality of connector components are configured to electrically connect the plurality of inductive charging tracks. The plurality of connector components may be track wire connector components. Each track wire connector component electrically connects two of the inductive charging tracks. Each track wire connector component comprises an A/C input and an A/C output connected by a wire. The A/C input of each track wire connector component attaches to and receives power from the A/C output on an upstream inductive charging track. The A/C output of each track wire connector component attaches to and transfers power to the A/C input on a downstream inductive charging track.

The plurality of connector components may be track corner connector components. Each track corner connector component electrically connects two of the inductive charging tracks at an angle. Each track corner connector component comprises an A/C input and an A/C output connected by an angled housing. The A/C input of each track corner connector component attaches to and receives power from the A/C output on an upstream inductive charging track. The A/C output of each track corner connector component attaches to and transfers power to the A/C input on a downstream inductive charging track.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of an inductive charging track of the present invention for wirelessly charging rechargeable electronic devices in accordance with the disclosed architecture.

FIG. 2 illustrates a rear overhead view of a wall facing side of the inductive charging track of the present invention for wirelessly charging rechargeable electronic devices in accordance with the disclosed architecture.

FIG. 3 illustrates an exploded side view of the inductive charging track of the present invention for wirelessly charging rechargeable electronic devices mounting to a wall in accordance with the disclosed architecture.

FIG. 4 illustrates a front perspective view of a plurality of electronic device retaining components of the inductive charging track of the present invention for wirelessly charging rechargeable electronic devices in accordance with the disclosed architecture.

FIG. 5 illustrates a perspective view of an outward facing side of a flexible housing peeled away to expose a power transfer component of the inductive charging track of the present invention for wirelessly charging rechargeable electronic devices in accordance with the disclosed architecture.

FIG. 6 illustrates an overhead view of the power transfer component of the inductive charging track of the present invention for wirelessly charging rechargeable electronic devices in accordance with the disclosed architecture.

FIG. 7 illustrates a front perspective view of the inductive charging track of the present invention for wirelessly charging rechargeable electronic devices in accordance with the disclosed architecture.

FIG. 8 illustrates a perspective view of one embodiment of an inductive charging system of the present invention for wirelessly charging rechargeable electronic devices in accordance with the disclosed architecture.

FIG. 9 illustrates a perspective view of the inductive charging system of the present invention for wirelessly charging rechargeable electronic devices in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is an inductive charging track and system that can replace traditional plugs in a residential or commercial setting. The inductive charging track may comprise a dimmer base connected to a magnetic flat track. The dimmer base and the flat track may be used as a power pack. A wall panel sized LEGO grid may be installed with conventional fasteners, such as screws, to anchor and connect wall panels. Wiring runs behind the wall to provide power to a magnetic compound which can be painted over. Wireless lights with rechargeable batteries can be easily fitted to the room and are powered by the energy from the wall. Other electronic devices can be also charged using the system.

The present inductive charging system is advantageous in that the electrical connections are protected preventing corrosion and decreasing the risk of electrical faults such as short circuit due to insulation failure, especially where connections are made or broken frequently. It also improves durability as there is significantly less wear and tear on the socket of the device and the attaching cable due to illuminating the need to constantly plug and unplug devices. Inductive charging systems can be operated automatically without dependence on people to plug and unplug. Further there is an increased convenience and aesthetic quality as there is no longer a need for cables.

The inductive charging track is configured to charge a plurality rechargeable electronic devices, such as electric toothbrushes, lights, speakers, smart phones, tablets, and other portable electronic devices wirelessly and simultaneously. No physical electrical connection is needed between the inductive charging track and the electronic devices. Each electronic device will have a secondary receiving induction coil, a rectifier for converting the transferred alternating current (A/C) power to direct current (D/C), and a rechargeable battery chargeable by the rectifier directly or through a charging circuit.

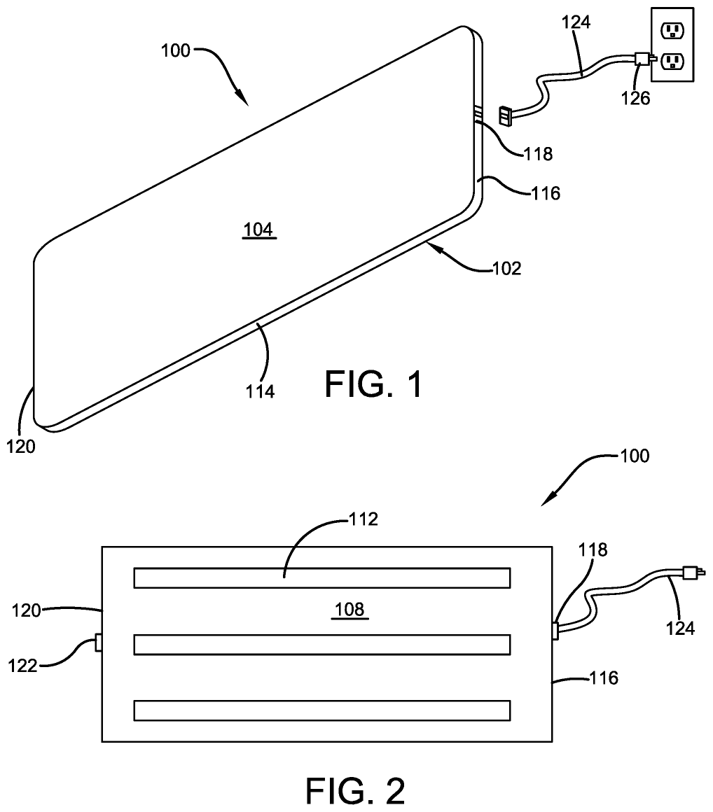

Referring initially to the drawings, FIGS. 1-7 illustrate an inductive charging track 100. The inductive charging track 100 comprises a housing 102 and a power transfer component 134. The inductive charging track 100 is configured to wirelessly charge a plurality of rechargeable electronic devices simultaneously. The inductive charging track 100 comprises a housing 102 and a power transfer component 134. The housing 102 is adapted to receive and retain the plurality of rechargeable electronic devices. The housing 102 may be a flexible mat that is rollable and bendable or constructed in a rigid track. The housing 102 may be deployed horizontally on a surface or attach vertically on a wall. In a horizontal orientation, the electronic devices may be placed on or adjacent to the housing 102 to be charged.

As illustrated in FIGS. 1 and 2, the housing 102 comprises an outward facing side 104, a wall facing side 108, and a perimeter 114. The outward facing side 104 is the charging surface. The plurality of rechargeable electronic devices may be laid on or placed in proximity to the outward facing side 104 for recharging. As illustrated in FIG. 4, the outward facing side 104 may comprise a plurality of electronic device retaining components 106. The plurality of electronic device retaining components 106 are constructed for holding the plurality of rechargeable electronic devices in place on the housing 102 when the housing 102 is attached to a vertical surface. The plurality of electronic device retaining components 106 may be brackets, hooks, shelves, hook and loop fasteners, or the like. The plurality of electronic device retaining components 106 may be integrated into or attachable to the outward facing side 104 anywhere along the surface.

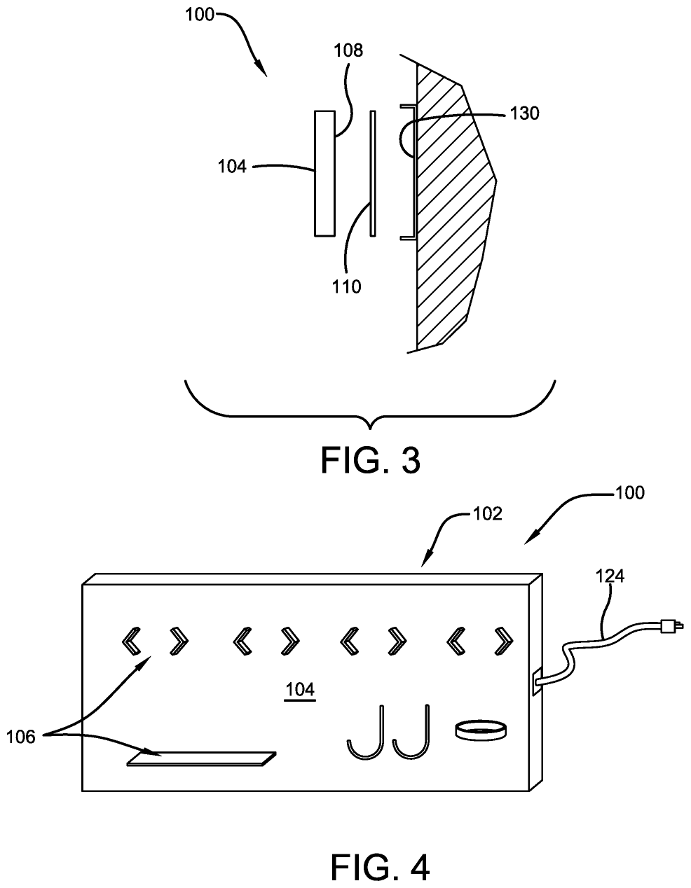

As illustrated in FIGS. 2 and 3, the wall facing side 108 comprises a wall attachment component 112 for attaching the housing 102 to a wall. The wall attachment component 112 may be use adhesive or mechanical fasteners to attach the wall facing side 108 to the surface. The wall facing side 108 may further comprise a metal back plate 110. The metal back plate 110 may be positioned between the wall facing side 108 and the wall allowing for magnetic attachment to the housing 102. The inductive charging track 100 may further comprise a mounting channel 130. The mounting channel 130 is adapted to mount to the wall and receive and hold the housing 102 in place as illustrated in FIG. 3.

The housing 102 may be generally rectangular or elongated in orientation further comprising a proximal end 116 and a distal end 120. The inductive charging track 100 further comprises an A/C input 118. The A/C input 118 is integrated into the proximal end 116. The inductive charging track 100 may further comprise a power cord 124. The power cord 124 is adapted to electrically connect the A/C input 118 to an external power source via an outlet via a plug 126. The power cord 124 may be detachable from or permanently connected to the A/C input 118. The inductive charging track 100 may further comprise an A/C outlet 122. The A/C outlet 122 is integrated into the distal end 120 of the housing 102.

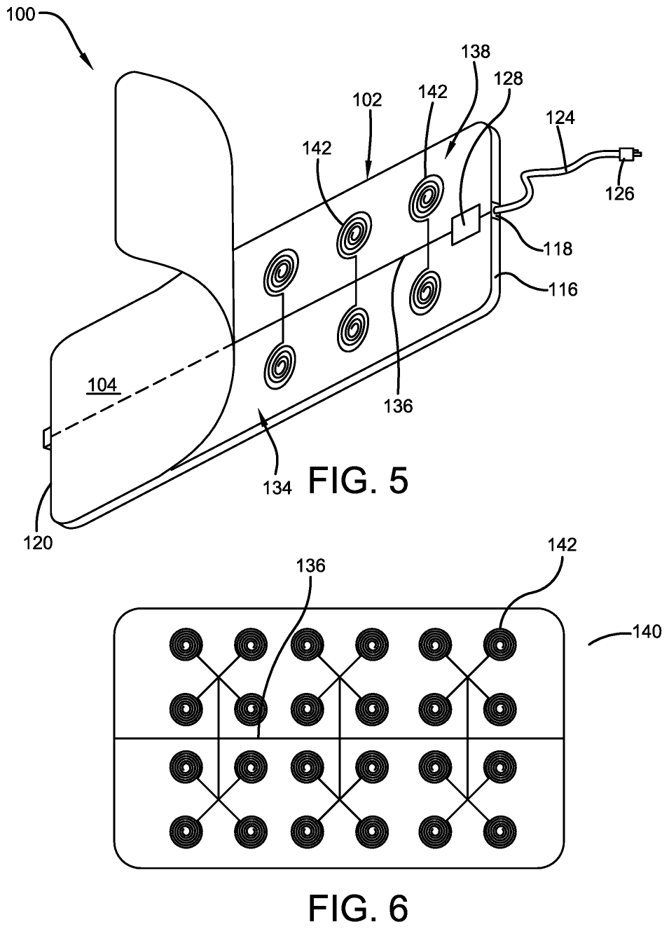

As illustrated in FIGS. 5 and 6, the power transfer component 134 is encased within and completely encapsulated or sandwiched by the housing 102. This construction protects the power transfer component 134 from damage. The power transfer component 134 comprises a transmitter circuit 136 and an inductive component 138. The inductive component 138 is in electronic communication with and electrically coupled to the transmitter circuit 136. The A/C input 118 electrically couples the transmitter circuit 136 to the external power source. The inductive charging track 100 may further comprise a controller 128 for operating the inductive charging track 128. The controller 128 is in electrical communication with the transmitter circuit 136.

The inductive component 138 comprises a plurality of charging regions 140. Each charging region 140 comprising at least one inductive transmitter coil 142. The charging regions 140 are located to provide inducting overlap throughout the housing 102 to provide as much charging surface as possible. For example, four inductive transmitter coils 142 could be located in each charging region 140 as illustrated in FIG. 6. Each inductive charging coil 142 functions as a transmitter to convert the A/C power to an electromagnetic field that is capturable by a corresponding receiving coil in one of the electronic devices. The plurality of inductive transmitter coils 142 are arranged in a planar orientation throughout the housing 102. The plurality of inductive transmitter coils 142 are electrically interconnected in series, parallel, or a combination thereof.

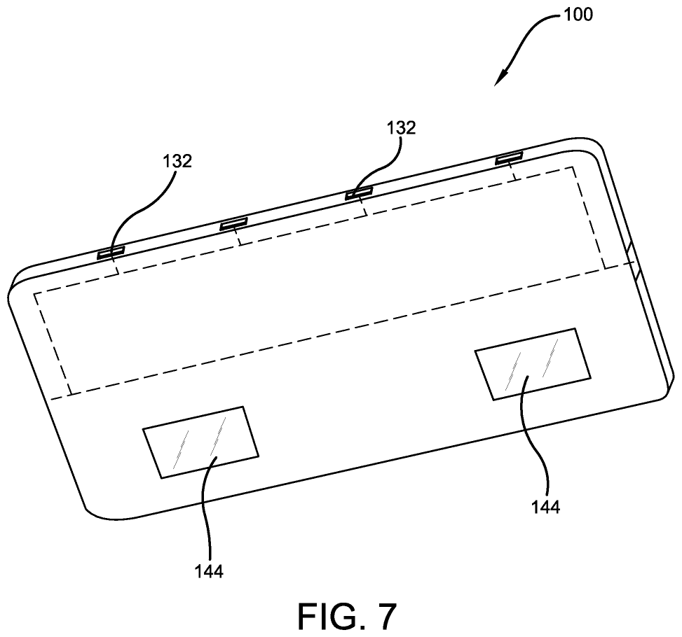

As illustrated in FIG. 7, the inductive charging track 100 may further comprise a plurality of USB connections 132. Each USB connection 132 is integrated into the housing 102 and receives power via an electrical connection to the transmitter circuit 136. The inductive charging track 100 may further comprise a plurality of lighting components 144. Each lighting component 144 is attachable to or integrated into the outward facing side 104 of the housing 102 or along the perimeter 114. Each lighting component 144 is configured to be powered inductively by the inductive charging track 100 and would use a receiving coil and a rectifier to charge a battery to power each lighting component 144.

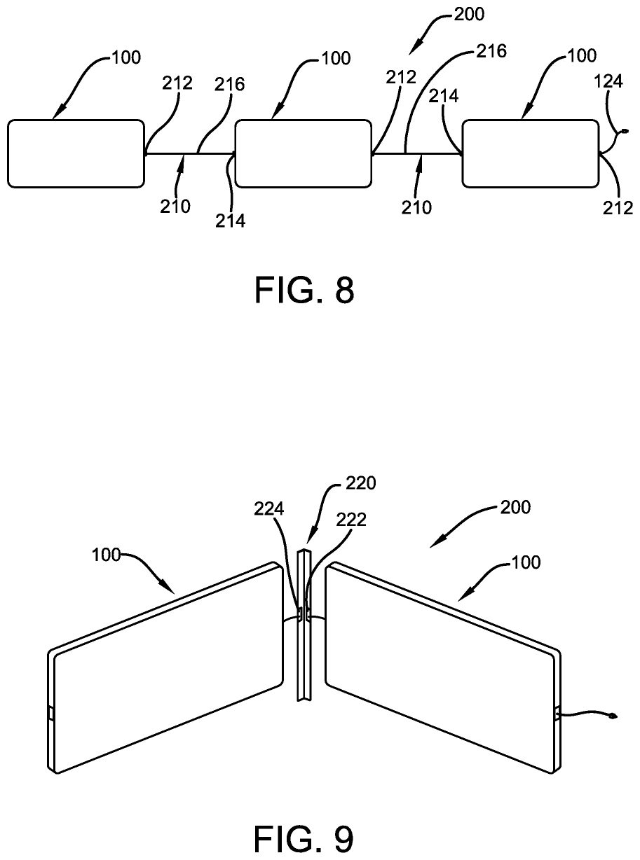

In an additional embodiment as illustrated in FIGS. 8 and 9, the subject matter disclosed and claimed herein comprises an inductive charging system 200. The inductive charging system 200 comprises a plurality of inductive charging tracks 100 and a plurality of connector components 210 and 220. Each inductive charging track 100 is configured to wirelessly charge a plurality of rechargeable electronic devices simultaneously. Each inductive charging track 100 comprises a housing 102 and a power transfer component 134. The housing 102 is adapted to receive and retain the plurality of rechargeable electronic devices. The housing 102 may be a flexible mat that is rollable or constructed in a rigid track.

The housing 102 comprises an outward facing side 104, a wall facing side 108, and a perimeter 114. The outward facing side 104 is the charging surface. The outward facing side 104 may comprise a plurality of electronic device retaining components 106. The plurality of electronic device retaining components 106 are constructed for holding the plurality of rechargeable electronic devices in place on the housing 102 when the housing 102 is attached to a vertical surface. The plurality of electronic device retaining components 106 may be brackets, hooks, shelves, hook and loop fasteners, or the like. The plurality of electronic device retaining components 106 may be integrated into or attachable to the outward facing side 104 anywhere along the surface.

The wall facing side 108 comprises a wall attachment component 112 for attaching the housing 102 to a wall. The wall attachment component 112 may be use adhesive or mechanical fasteners to attach the wall facing side 108 to the surface. The wall facing side 108 may further comprise a metal back plate 110. The metal back plate 110 may be positioned between the wall facing side 108 and the wall allowing for magnetic attachment to the housing 102. The inductive charging track 100 may further comprise a mounting channel 130. The mounting channel 130 is adapted to mount to the wall and receive and hold the housing 102 in place.

The housing 102 may be generally rectangular or elongated in orientation further comprising a proximal end 116 and a distal end 120. Each inductive charging track 100 further comprises an A/C input 118. The A/C input 118 is integrated into the proximal end 116. At least one of the inductive charging tracks 100 may further comprise a power cord 124. The power cord 124 is adapted to electrically connect the A/C input 118 to an external power source via an outlet via a plug 126. The power cord 124 may be detachable from or permanently connected to the A/C input 118. Each inductive charging track 100 further comprises an A/C outlet 122. The A/C outlet 122 is integrated into the distal end 120 of the housing 102 for allowing power to transfer to another inductive charging track 100 as discussed infra.

The power transfer component 134 is encased within and completely encapsulated or sandwiched by the housing 102. The power transfer component 134 comprises a transmitter circuit 136 and an inductive component 138. The inductive component 138 is in electronic communication with and electrically coupled to the transmitter circuit 136. The A/C input 118 electrically couples the transmitter circuit 136 to the external power source. The inductive charging track 100 may further comprise a controller 128 for operating the inductive charging track 128. The controller 128 is in electrical communication with the transmitter circuit 136.

The inductive component 138 comprises a plurality of charging regions 140. Each charging region 140 comprising at least one inductive transmitter coil 142. The charging regions 140 are located to provide inducting overlap throughout the housing 102 to provide as much charging surface as possible. Each inductive charging coil 142 functions as a transmitter to convert the A/C power to an electromagnetic field that is capturable by a corresponding receiving coil in one of the electronic devices. The plurality of inductive transmitter coils 142 are arranged in a planar orientation throughout the housing 102. The plurality of inductive transmitter coils 142 are electrically interconnected in series, parallel, or a combination thereof.

The plurality of connector components 210 and 220 are configured to electrically connect each of the plurality of inductive charging tracks 110. As illustrated in FIG. 8, the plurality of connector components may be track wire connector components 210. Each track wire connector component 210 electrically connects two of the inductive charging tracks 110 in series. Each track wire connector component 210 comprises an A/C input 212 and an A/C output 214 connected by a wire 216. The A/C input 212 of each track wire connector 210 component attaches to and receives power from the A/C output 122 on an upstream inductive charging track 100. The A/C output 214 of each track wire connector component 210 attaches to and transfers power to the A/C input 118 on a downstream inductive charging track 100. This configuration allows for as many inductive charging tracks 100 to be connected as desired depending on the needs of the user.

The plurality of connector components may also or alternatively be track corner connector components 220. Each track corner connector component 220 electrically connects two of the inductive charging tracks 100 at an angle. Each track corner connector component 220 comprises an A/C input 222 and an A/C output 224 connected by an angled housing 226. The A/C input 222 of each track corner connector component 220 attaches to and receives power from the A/C output 122 on an upstream inductive charging track 100. The A/C output 224 of each track corner connector component 220 attaches to and transfers power to the A/C input 218 on a downstream inductive charging track 100. This configuration allows for inductive charging tracks 100 to surround the perimeter of a room similar to a chair rail molding.

Notwithstanding the forgoing, the inductive charging track and system 100 and 200 can by any suitable size, shape, and configuration as is known in the art without affecting the overall concept of the invention, provided that it accomplishes the above stated objectives. One of ordinary skill in the art will appreciate that the shape and size of the inductive charging track and system 100 and 200 and its various components, as show in the FIGS. are for illustrative purposes only, and that many other shapes and sizes of the inductive charging track and system 100 and 200 are well within the scope of the present disclosure. Although dimensions of the inductive charging track and system 100 and 200 and its components (i.e., length, width, and height) are important design parameters for good performance, the inductive charging track and system 100 and 200 and its various components may be any shape or size that ensures optimal performance during use and/or that suits user need and/or preference. As such, the inductive charging track and system 100 and 200 may be comprised of sizing/shaping that is appropriate and specific in regard to the intended use.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An inductive charging track comprising:
a flexible housing adapted to receive a plurality of rechargeable electronic devices;
a power transfer component encased within the flexible housing, the power transfer component comprising a transmitter circuit electrically coupled to an inductive component comprising a plurality of charging regions, each charging region comprising at least one inductive transmitter coil; and
an A/C input for electrically connecting the transmitter circuit to an external power source.

2. The inductive charging track of claim 1, wherein the flexible housing is rollable.

3. The inductive charging track of claim 1, wherein the flexible housing comprises an outward facing side comprising a plurality of electronic device retaining components.

4. The inductive charging track of claim 3, wherein the plurality of electronic device retaining components are brackets, hooks, shelves, or hook and loop attachments.

5. The inductive charging track of claim 1, wherein the flexible housing is adapted to attach to a wall surface.

6. The inductive charging track of claim 1, wherein the flexible housing comprises a wall facing surface and a metal back plate attached to the wall facing surface.

7. The inductive charging track of claim 1 further comprising a wall mounting channel for receiving and attaching the flexible housing to a wall.

8. The inductive charging track of claim 1, wherein the plurality of inductor coils are arranged in a planar orientation.

9. The inductive charging track of claim 1, wherein the plurality of inductor coils are electrically interconnected in series.

10. The inductive charging track of claim 1, wherein the plurality of inductor coils are electrically interconnected in parallel.

11. The inductive charging track of claim 1, wherein the plurality of inductor coils are electrically interconnected in a combination of series and parallel.

12. An inductive charging track comprising:
a housing adapted to receive a plurality of rechargeable electronic devices;
a power transfer component encased within the housing, the power transfer component comprising a transmitter circuit electrically coupled to an inductive component comprising a plurality of charging regions, each charging region comprising at least one inductive transmitter coil;
an A/C input for electrically connecting the transmitter circuit to an external power source via a power cord; and
an A/C output.

13. The inductive charging track of claim 12 further comprising a plurality of USB connections integrated into the housing in electrical communication with the transmitter circuit.

14. The inductive charging track of claim 12, wherein each charging region comprises four inductive transmitter coils.

15. The inductive charging track of claim 12 further comprising a controller in electrical communication with the transmitter circuit.

16. The inductive charging track of claim 12 further comprising a plurality of inductively chargeable lighting components attachable to the housing.

17. An inductive charging system comprising:
a plurality of inductive charging tracks, each inductive charging track comprising:
a housing adapted to receive a plurality of rechargeable electronic devices;
a power transfer component encased within the housing, the power transfer component comprising a transmitter circuit electrically coupled to an inductive component comprising a plurality of charging regions, each charging region comprising at least one inductive transmitter coil; and
an A/C input for electrically connecting the transmitter circuit to an external power source; and
an A/C output; and
a plurality of connector components for electrically connecting the plurality of inductive charging tracks.

18. The inductive charging system of claim 17, wherein the plurality of connector components are a plurality of track wire connector components each comprising a wire, an A/C input, and an A/C output.

19. The inductive charging system of claim 18, wherein the A/C input of each track connector component receives power from an A/C output of an upstream inductive charging tracks and transfers power to an A/C input of a downstream inductive charging track via the A/C output of the track connector component.

20. The inductive charging system of claim 17, wherein the plurality of connector components are a plurality of track corner connector components each comprising an angled housing, an A/C input, and an A/C output.
